(19) United States
(12) Patent Application Publication
(10) Pub. No.: US 2002/0139551 A1
(43) Pub. Date: Oct. 3, 2002

(54) Striker for a pile driver, and pile driver with such a striker

(76) Inventor: Stefan Mewes, Esslingen (DE)

Correspondence Address: FACTOR & PARTNERS, LLC, 1327 W. WASHINGTON BLVD., SUITE 5G/H, CHICAGO, IL, 60607, US

(21) Appl. No.: 10/113,527

(22) Filed: Mar. 29, 2002

(30) Foreign Application Priority Data
Mar. 31, 2001 (DE) 101 15 833.5

(51) Int. Cl. B25D 9/00

(52) U.S. Cl. 173/114

(57) ABSTRACT

A striker for a diesel pile driver has a piston section, a shaft section and a striking section. The striking section has one or more steps on an outside surface and/or on an inside surface. These steps serve to produce a load-transmitting form closure with pile-driving material of different diameters.

The invention concerns a striker for a pile driver, in particular, a diesel pile driver according to the pre-characterizing clause of Claim 1, as well as a pile driver with such a striker.

Diesel pile drivers which drive a striker by means of a heavy piston, running in a cylinder (two-stroke diesel engine), which in turn drives a tube or a pile into the ground via a driving cap, are known in the prior art (see, for example, the brochure “DELMAG Dieselb, ren, Einsatzbeispiele und Funktionsweisen” of DELMAG Maschinenfabrik, Reinhold Domfeld GmbH & Co., Esslingen).In the case of these strikers of the prior art, the striking section has a lower, rounded striking surface which projects out of a flange of the cylinder. Above the striking section, the striker has a shaft section and a piston section running in a sealed manner in the lower end of the cylinder. The striker is generally composed of steel.

The round striking surface of the striking section of the known diesel pile driver works together with a driving cap, which is mounted on the upper end of a pile or tube. At its upper end, the driving cap has a casing which damps the impact of the striker, this being advantageous particularly in the case of pressure-sensitive pile-driving material. However, the driving cap must be individually produced for each size of a pile or tube that is to be driven into the ground. This is demanding of resources, and costly.

It would be desirable to have available a striker capable of working together directly with pile-driving material of different sizes, without an intermediate driving cap. This is the object of the present invention.

This object is achieved, according to the invention, by the striker according to claim 1.

The striker according to the invention, which is normally of metal, has steps in the form of an inverted stairway, each of which works together directly with a tube or pile of corresponding diameter which is to be driven into the ground, without the use of a driving cap. The steps located on the outside of a striker according to the invention are suitable for working together with tubes of different diameters, whilst steps provided on an inner side are suitable for working together with piles of different diameters.

If a striking section has, for example, three outer steps and three inner steps, it can be used for driving three tubes of different diameters and three piles of different diameters into the ground, thus resulting in a saving of six driving caps. Alternatively, the striker may have steps only on the inside or only on the outside.

Advantageous developments are disclosed in the sub-claims.

The steps can have bevels at their convex edges (Claim 2) and be rounded at their concave edges (Claim 3), preventing high notch stresses.

The indentation of the outer steps is matched to the maximum thickness of a tube wall. For reasons of mechanical stability, the ratio of indentation to height of a step is preferably approximately 0.65 to 1.0 (Claim 4).

If the striker has outer steps only, it can have a recess, approximately in the form of a paraboloid, in the space between the steps. This reduces the weight of the striker, while still maintaining a high mechanical load stability (Claim 5).

Between the topmost step and the start of the shaft section, the striking section of the striker preferably has the form of an upwardly tapering truncated cone. This provides a sufficiently large diameter of the striking section to accommodate several steps on the striking section (Claim 6). The ratio of the height of the striking section to its largest diameter is then in the range of 0.35 to 0.52 (Claim 7).

The development of the invention according to Claim 8 allows the striker to be used with a plurality of pile-driving materials of different geometries.

The annular underside of the piston section of the striker preferably works together with a damping element disposed on a shoulder of the cylinder section surrounding the striker (Claim 9), whilst a topmost annular end face of the striking section works together with a damping ring on the end of the cylinder surrounding the striker (Claim 10), so that damping is effected on both the downward and upward movements of the striker.

The striking section finally works together, preferably, with sealing rings on the surrounding cylinder (Claim 11).

### BRIEF DESCRIPTION OF THE DRAWINGS

The invention is explained more fully below with the aid of an embodiment example and with reference to the drawing, wherein:

FIG. 1: shows a partially sectional view of a striker and the lower end of a diesel pile hammer, two embodiments being shown, on the right and left of the central line;

and

FIG. 2: shows a side view of a striker on which there is mounted an adapter piece.

### DETAILED DESCRIPTION OF THE DRAWINGS

In the figure, 10 denotes a striker of a diesel pile driver. The striker comprises a piston section 12, a shaft section 14 and a striking section 16 of a height H. At the piston section 12 and at the shaft section 14, the striker is surrounded by a cylinder 40. A cylinder end ring 26 and a cylinder main part 46 are screwed together by screws 24. A stop ring 32 with a retaining rib 33 is clamped between the adjacent ends of the cylinder main part 46 and the cylinder end ring 26.

The stop ring 32 has an upper rotationally symmetrical end face 44, which slopes slightly downwards and above which there is a damping ring 30.

The cylinder 40 is sealed towards the shaft section 14 by sealing rings 34 which are let into the inside surface of the stop ring 32. Located at the lower end face of the cylinder 40 is a further damping ring 28, having a widened foot section, which is held between lugs 52, 54, distributed in the circumferential direction, which are provided externally at the lower end of the stop ring 32 and internally at the lower end of the cylinder end ring 26.

The striking section 16 of the striker 10 has an upper annular end face 47 which is adjacent to the shaft section14. It graduates downwards into apart 23, in the form of a truncated cone, of the striking section 16. This section23 in the form of a truncated cone has a greatest diameter d. The section 23 in the form of a truncated cone graduates down into a disc-shaped section 21.

The stepped portion of the striking section 16 is shown in a first embodiment form in the left half of the drawing, and in another embodiment form in the right half of the drawing.

Shown in the left half and in the right half of the drawing are steps 20a, 20b, 20c, on the outer circumference of the striking section 16, which extend downwards in the form of an inverted stairway. In their vertical sections, in the proximity of the convex step edges, the steps have bevels 36a which facilitate insertion in the upper end of a driving pipe. The concave edges of the steps are rounded, as shown at 38a. The steps are of a height h and have an indentation e.

Shown in the left portion of the drawing is an embodiment form in which the striking section 16 has a paraboloid-type recess 18 in its center, up to the level of the disc-shaped section 21. This recess serves to reduce the weight of the striker.

In the right half of the drawing, steps 22a, 22b, 22c are likewise fashioned in the inner part of the striking section 16. They, likewise, analogously with the outer steps, have bevels 36b and roundings 38b.

A third embodiment form of the invention (not shown) has only inner steps 22a, 22b, 22c and, instead of the outer steps 20a, 20b, 20c, has a downwardly tapering surface of an inverted truncated cone.

As mentioned above, the use of driving caps is rendered unnecessary by the use of the striker 10 according to the invention. The outer steps 20a, 20b, 20c of the striking section work together directly with a tube 56 (indicated by a broken line) to be driven into the ground, whilst the inner steps 22a, 22b, 22c work together directly with a pile 58 (indicated by a broken line) to be driven into the ground.

The upward and downward movement of the striker 10 relative to the surrounding cylinder 40 is damped by the two damping rings 28 and 30.

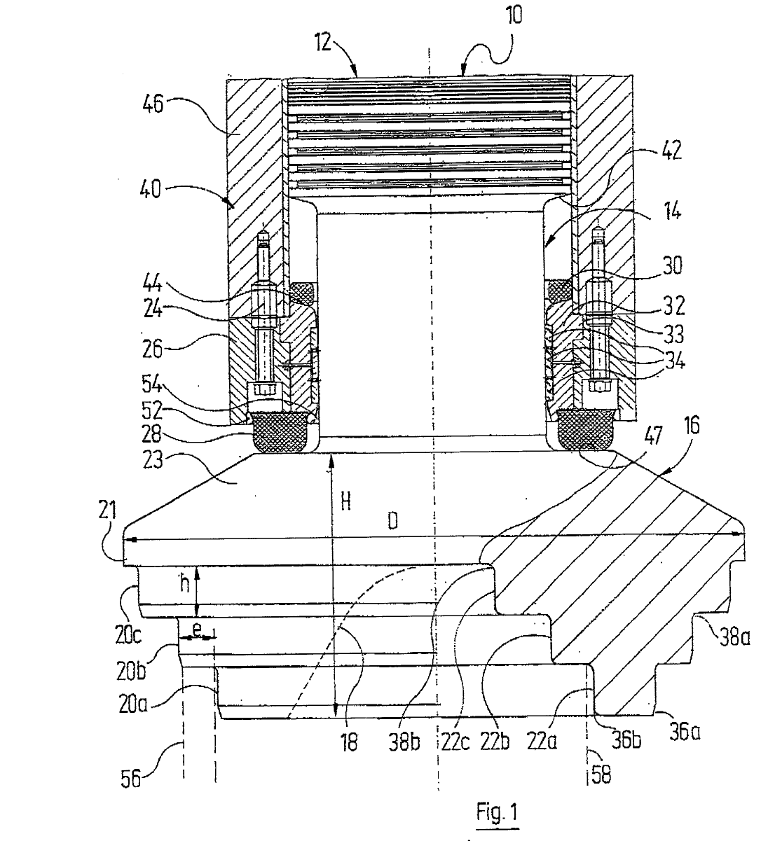

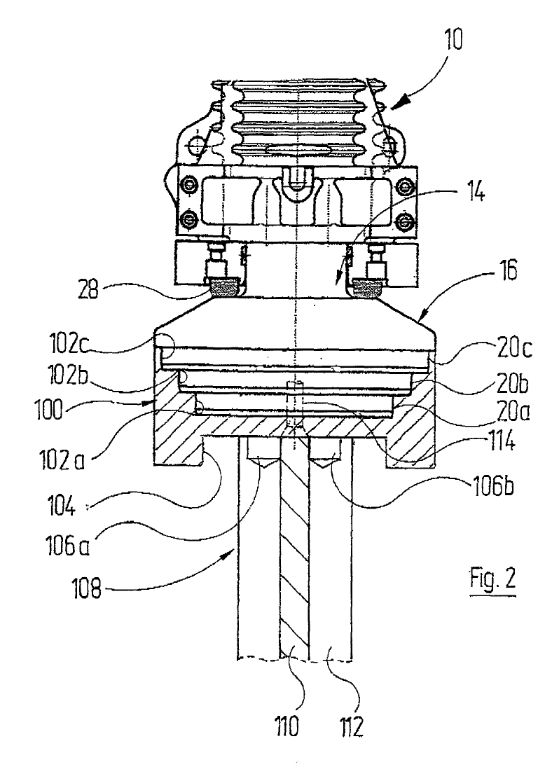

The striker according to FIG. 1 is suitable for use directly with cylindrical piles or cylindrical tubes of different diameters. Occasionally, however, there is a wish to drive into the ground with a given pile hammer not merely pile-driving materials with a geometrically similar geometry, but also pile-driving materials of a fundamentally different geometry, e.g. a sheet-pile wall element or I-type, or double-T, members. To enable a form closure to be produced with the upper end of the pile-driving material without the need to replace the striker, it is possible to use an adapter piece, as denoted by 100 in FIG. 2.

The adapter piece 100 is provided on its upper side with a multiply stepped recess which is complementary to the outer surface of the striker 16: the steps 102a, 102b, 102c of the adapter piece 100 correspond to the steps 20a, 20b, 20c of the latter. In this way, the adapter piece 100 is joined with a form closure to the striker 16.

The underside of the adapter piece 100 carries positioning pins 106a and 106b located symmetrically behind and in front of, respectively, the plane of the projection. Their spacing and position in a recess 104 in the underside of the adapter piece 100 are selected so that they engage with a form closure in the upper end of an I-type or double-T member 108. The spacing of the positioning pins in the horizontal direction in FIG. 2 corresponds to the thickness of the web 110 of the member 108, and the spacing of the positioning pins 106a and 106b from the mirror-image positioning pin, located in front of the plane of the projection, corresponds to the spacing of the two sides 112 of the member 108.

In this way, the upper end of the member 108 is joined with a form closure to the adapter piece 100 and, via the latter, is also joined with a form closure to the strikerl 6.

The adapter piece 100 can be easily replaced without partial disassembly of the diesel pile hammer, e.g. by undoing a central retaining screw 114, in order to drive members of different dimensions or of a fundamentally different geometry

What is claimed is:

1. A striker for a pile driver, in particular, a diesel pile driver, having a piston section, a shaft section and a striking section, characterized in that the striking section has one or more steps on at least one of an outside surface or on an inside surface.

2. The striker according to claim 1, characterized in that the steps have bevels at convex edges in each vertical section.

3. The striker according to claim 1, characterized in that the steps are rounded at concave edges.

4. The striker according to claim 1, characterized in that the steps have a ratio of indentation to height of approximately 0.65 to 1.0.

5. The striker according to claim 1, characterized in that it has steps on its outside surface only and the striking section has an internal recess, wherein the internal recess is a smoothly curved surface of revolution which preferably has the form of a paraboloid.

6. The striker according to claim 1, characterized in that the outside surface of the striking section has the form of a truncated cone.

7. The striker according to claim 1, characterized in that the ratio of the height of the striking section to the greatest diameter of the striking section is approximately 0.35 to 0.52.

8. The striker according to claim 1, characterized in that there is placed on the steps an adapter piece with complementary steps, which has form closure means, on a surface facing away from the complementary steps, which work together with the upper end of a pile driving material.

9. A pile driver, in particular, a diesel pile driver, with a striker according to claim 1, characterized in that a tapering portion of the piston section works together with a first damping ring on a shoulder of a cylinder surrounding the striker.

10. A pile driver, in particular a diesel pile driver, according to claim 9, with a striker, characterized in that a topmost annular end face of the striking section works together with a damping ring disposed on the end of a cylinder surrounding the striker.

11. A pile driver, in particular a diesel pile driver, according to claim 9, with a striker, characterized in that the shaft section works together with sealing rings.
